(19) United States
(12) Patent Application Publication
(10) Pub. No.: US 2024/0300521 A1
(43) Pub. Date: Sep. 12, 2024

(54) VEHICLE CONTROL ADAPTATION TO EXTERNAL ENVIRONMENTAL CONDITIONS

(71) Applicant: GM GLOBAL TECHNOLOGY OPERATIONS LLC, Detroit, MI (US)

(72) Inventors: Klaus Trangbaek, Ein Vered (IL); Mohammadali Shahriari, Markham (CA); Reza Zarringhalam, Whitby (CA); Ashraf Abualfellat, Grand Blanc, MI (US); Vaibhav J. Lawand, Northville, MI (US)

(73) Assignee: GM GLOBAL TECHNOLOGY OPERATIONS LLC, Detroit, MI (US)

(21) Appl. No.: 18/181,312

(22) Filed: Mar. 9, 2023

(51) Int. Cl. B60W 60/00; B60W 30/14; B60W 40/06

(52) U.S. Cl. CPC B60W 60/001; B60W 30/146; B60W 40/06; B60W 2420/00; B60W 2510/20; B60W 2555/20; B60W 2556/00

(57) ABSTRACT

A system and method for vehicle control adaptation to external environmental conditions includes receiving, by a controller, weather and roadway condition data, from an external source. The weather and roadway condition data includes a sustained wind velocity, a sustained wind direction, and a wind gust level for a location of the vehicle. The controller receives vehicle measurement data from one or more sensors situated within the vehicle and determines a criticality of a wind impact on the vehicle based on the weather and roadway data and the vehicle measurement data. The controller than generates feedback and/or a control based on the criticality of the wind impact.

### INTRODUCTION

Vehicles are a staple of everyday life. Special use cameras, microcontrollers, laser technologies, and sensors may be used in many different applications in a vehicle. Cameras. microcontrollers and sensors may be utilized in enhancing automated structures that offer state-of-the-art experience and services to the customers, for example in tasks such as steering and body control, camera vision, information display, security, autonomous controls, etc. Vehicular control systems may also be used to assist in vehicle control including advanced driver assistance systems (“ADAS”).

Vehicular control systems may be used to provide the vehicle operator with information of the environment surrounding the vehicle. The control systems may also be used to assist in controlling the vehicle in response to external environmental conditions. For example, the force of a wind gust, depending on the type of vehicle, may produce extreme forces on the vehicle and compromise vehicle control. Sustained wind levels, defined as the wind speed, or wind level, as determined by averaging observed values over a two-minute period by the National Oceanic and Atmospheric Administration (“NOAA”), may reach high levels that are enough to impair vehicle control. Further, wind gusts, defined by the NOAA as rapid fluctuations in the wind speed with a variation of ten knots or more between peaks and lulls, may pose even greater threats, especially given the unpredictability of wind gusts. Accordingly, it is desirable to provide a system and method of vehicle control adaptation to external environmental conditions.

### SUMMARY

Disclosed herein are a system and methods for vehicle control adaptation to external environmental conditions. As disclosed herein, a system for a vehicle control adaptation to external environmental conditions may include a controller situated within a vehicle that receives, from an external source, weather and roadway condition data, based on a location of the vehicle. Further, the weather and roadway condition data may include various data, for example, a sustained wind velocity, a sustained wind direction, and a wind gust level. In addition, the weather and roadway condition data may also include traffic data and road condition data such as icing, wet, or reduced traction. The controller may also receive vehicle measurement data from one or more sensors situated within the vehicle. The controller may also determine a route criticality score based on the weather and roadway data and the vehicle measurement data.

In another aspect of the disclosure the system may include that the external source is crowd-sourced data, for example from a social media platform, a cloud-based retrieval system, or automatically from other vehicles.

In another aspect of the disclosure of the system the weather and roadway condition data may also include traffic data.

In another aspect of the disclosure the controller may generate a feedback and/or a control based on the route criticality score.

In another aspect of the disclosure the vehicle measurement data may include a velocity of the vehicle, a steering angle of the vehicle, and a yaw rate of the vehicle.

In another aspect of the disclosure the feedback and/or the control may include a steering torque applied to a steering system of the vehicle.

In another aspect of the disclosure the feedback and/or the control may include a limiting of vehicle speed.

As disclosed herein, a system for a vehicle control adaptation to external environmental conditions may include a controller situated within a vehicle that may access, from a server, a road criticality map. The road criticality map may be based on geographically mapped condition data from an external source. Further, the road criticality map may include data components such as a sustained wind velocity, a sustained wind direction, and a wind gust level. The controller may also receive vehicle measurement data from one or more sensors situated within the vehicle and then determine a criticality of wind impact on the vehicle based on the road criticality map and the vehicle measurement data. The controller may then generate feedback and/or a control based on the criticality of wind impact on the vehicle.

In another aspect of the disclosure the road criticality map may be a shared map of road criticality for a geographic area.

In another aspect of the disclosure the road criticality map may include traffic data.

In another aspect of the disclosure the external source may be crowd-sourced data, for example from a social media platform, a cloud-based retrieval system, or automatically from other vehicles.

In another aspect of the disclosure the vehicle measurement data may include a velocity of the vehicle, a steering angle of the vehicle, and a yaw rate of the vehicle.

In another aspect of the disclosure the feedback and/or the control may include a steering torque applied to a steering system of the vehicle.

In another aspect of the disclosure the feedback and/or the control may include a limiting of vehicle speed.

In another aspect of the disclosure the feedback and/or the control may include generating a warning indication to an occupant of the vehicle.

Another aspect of the disclosure may include a method for vehicle control adaptation to external environmental conditions. The method may include receiving, by a controller, weather and roadway condition data, from an external source. The weather and roadway condition data may include a sustained wind velocity, a sustained wind direction, and a wind gust level for a location of the vehicle. The method may continue by receiving, by the controller, a vehicle measurement data from one or more sensors situated within the vehicle. The method may determine, by the controller, a criticality of a wind impact on the vehicle based on the weather and roadway data and the vehicle measurement data. The method may then generate, by the controller, feedback and/or a control based on the criticality of the wind impact.

In another aspect of the method the vehicle measurement data may include a velocity of the vehicle, a steering angle of the vehicle, and a yaw rate of the vehicle.

In another aspect of the method may include applying a steering torque to a steering system of the vehicle when the criticality of the wind impact exceeds a predetermined threshold.

In another aspect of the method may include limiting a speed of the vehicle when the criticality of the wind impact exceeds a predetermined threshold.

In another aspect of the method may include generating a route criticality score based on the location of the vehicle and a possible route of the vehicle.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an illustration of crosswind forces on a vehicle, in accordance with the disclosure.

FIGS. 2A, 2B, and 2C are illustrations of wind and gust direction vectors, in accordance with the disclosure.

FIG. 3 is a block diagram of a vehicle-specific criticality scoring system, in accordance with the disclosure.

FIG. 4 is a block diagram of a criticality map generation system, in accordance with the disclosure.

FIG. 5 is an example table of control settings for adaptation to wind and wind sensitivity, in accordance with the disclosure.

FIG. 6 depicts a flowchart of a method for vehicle control adaptation to external environmental conditions, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

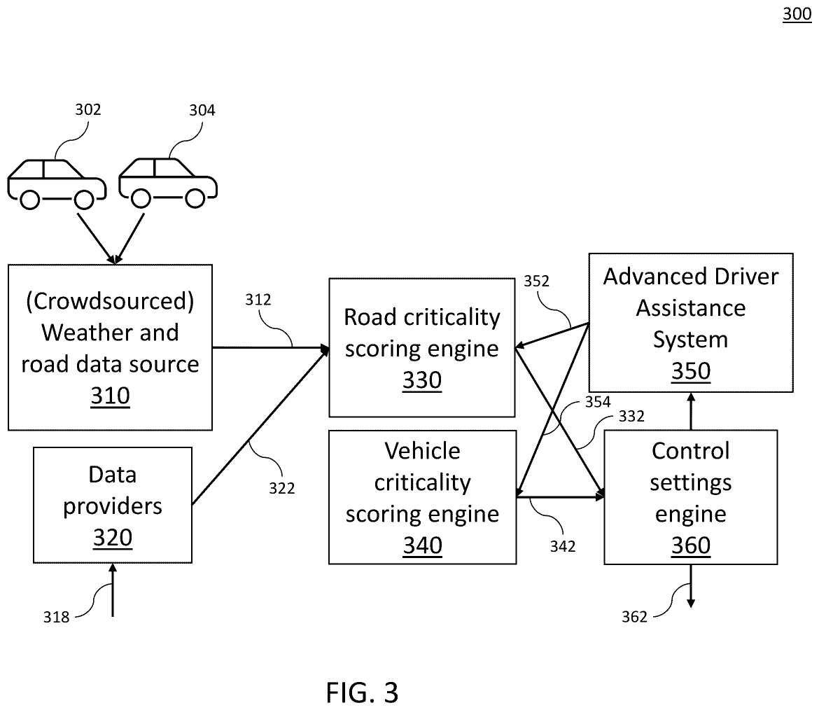

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

Vehicles have become computationally advanced and equipped with multiple microcontrollers, sensors, processors, and control systems, including for example, autonomous vehicle and advanced driver assistance systems (AV/ADAS) such as adaptive cruise control, automated parking, automatic brake hold, automatic braking, evasive steering assist, lane keeping assist, adaptive headlights, backup assist, blind spot detection, cross traffic alert, local hazard alert, and rear automatic braking may depend on information obtained from sensors on a vehicle or external sources such as the cloud and/or crowd-sourced bases such as automatically sharing data and information from other vehicles.

Further, during roadway operation of a vehicle by a vehicle operator, semi-autonomously or fully autonomous, the vehicle may encounter environmental challenges including changing weather conditions. Sensitivity to weather conditions pose a problem for the self-driving experience. Weather conditions, including crosswinds may present challenges to vehicle operation and control and thus the use of crosswind detection and mitigation may be used to compensate for such conditions.

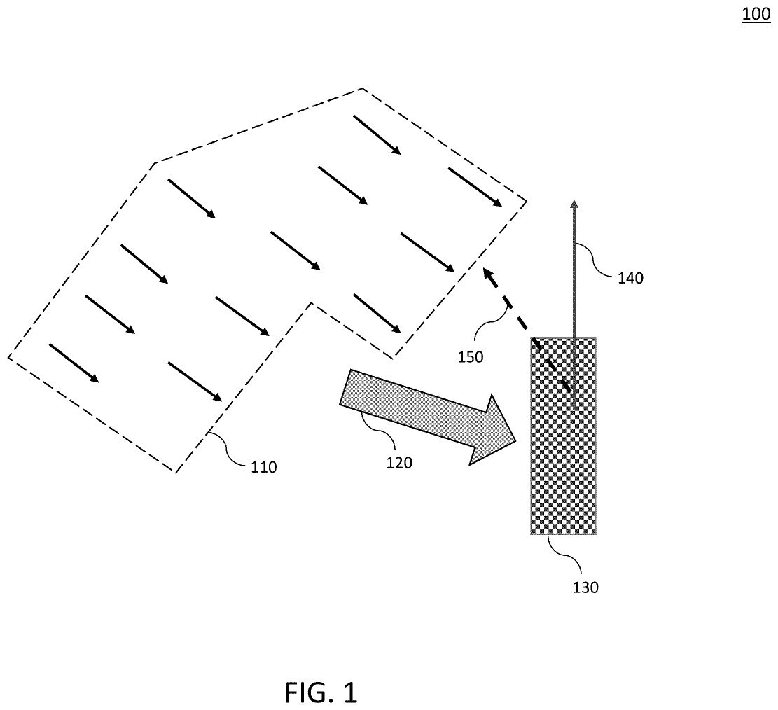

FIG. 1 is an illustration of crosswind forces scenario 100 on a vehicle, according to an embodiment of the present disclosure. Scenario 100 includes wind vectors 110, a composite wind force 120, and a vehicle 130. Wind vectors 110 are an illustration of a direction of the wind and a velocity of the wind. Further, wind vectors 110 may include two components of wind. A first component may consist of a sustained wind value while a second component may consist of a gust wind level. The sustained wind value is typically predictable and observable while the gust wind level component may be hard to predict or observe.

The result of the force of the wind vectors 110 may be illustrated as the composite wind force 120 that illustrates a total force and a direction of the wind on the vehicle 130. Vehicle 130 is illustrated as traveling along a direction and velocity vector 140. However, given the wind force 120, which may also be referred to as a wind impact, results in a torque to alter the direction of travel of the vehicle 130 along the direction of vector 150. Depending upon the characteristics of the vehicle 130 and the direction of velocity of the wind vectors 110, a sudden wind impact upon vehicle 130 may result in a very undesirable change in direction of travel. To mitigate such effects, the present disclosure presents a multi-factor compensation approach directed to a high bandwidth component and a low bandwidth component of the crosswind.

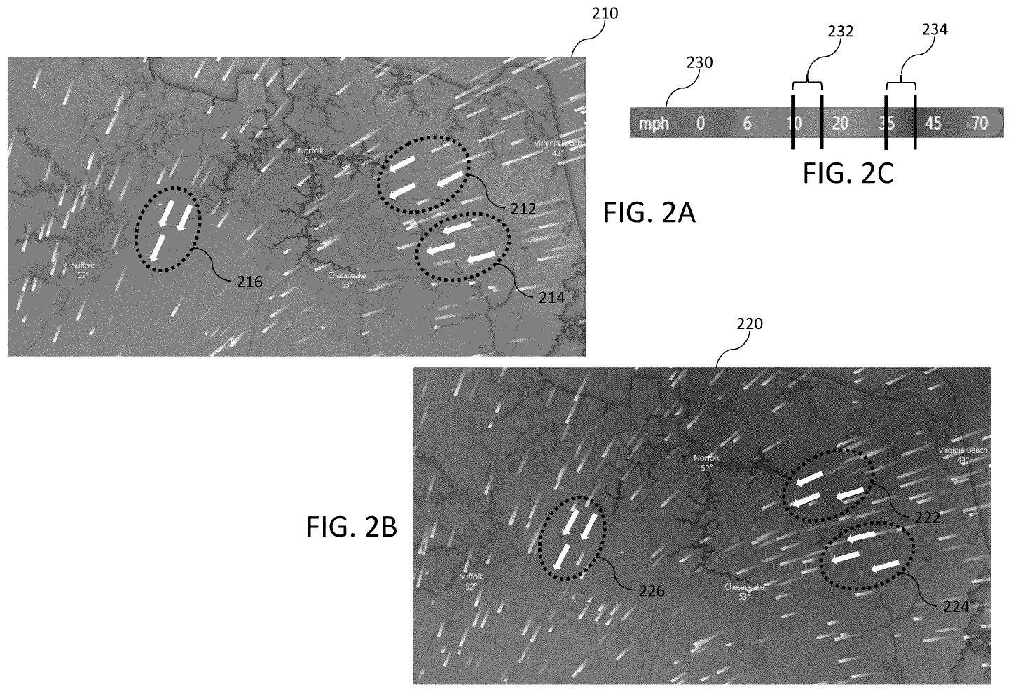

FIGS. 2A, 2B, and 2C are illustrations of a wind speed and direction, gust speed and direction, and an associated speed index, according to an embodiment of the present disclosure. Specifically, FIG. 2A illustrates a wind vector scenario 210 containing wind vectors such as the highlighted wind vectors 212, wind vectors 214, and wind vectors 216. The randomly selected highlighted vectors are just examples showing different directions of wind within the mapped area. The wind vectors 212, wind vectors 214, and wind vectors 216 also indicate a sustained wind velocity of approximately 10 to 15 miles per hour as shown by range 232 on the index 230 in FIG. 2C. Further, the data illustrated by FIG. 2A and FIG. 2B represent an area of wind activity that may be provided by a third-party entity or by multiple vehicles capturing wind and gust data through onboard vehicle sensors.

Further, FIG. 2B illustrates a gust vector scenario 220 containing gust vectors such as the highlighted gust vectors 222, gust vectors 224, and gust vectors 226. The gust vectors 222, gust vectors 224, and gust vectors 226 also indicate a gust velocity of approximately 35 to 40 miles per hour as shown by range 234 on the index 230 in FIG. 2C. While the gust vectors in FIG. 2B may typically be in a similar direction as the wind vectors in FIG. 2A, they are not necessarily identical and in some situations may be significantly different.

FIG. 3 is a block diagram of a vehicle-specific criticality scoring system 300, according to an embodiment of the present disclosure. Vehicle-specific criticality scoring system 300 may be directed to collecting condition data for the location of the vehicle, combining that data with vehicle condition data and generating a criticality ranking. Based on the criticality ranking an action may be taken, for example, a warning, an imposition of limits, or an adjusting of control may be implemented.

Vehicle-specific criticality scoring system 300 may include a weather and road data source 310, which may be crowdsourced such as being automatically generated by another vehicle's controller or sensor. Vehicle-specific criticality scoring system 300 may also include other vehicles such as data source vehicle 302 and data source vehicle 304, data providers 320, a road criticality scoring engine 330, a vehicle criticality scoring engine 340, an advanced driver assistance system 350 and a control settings engine 360.

The weather and road data source 310 may collect data regarding the weather, road conditions, traffic, load conditions and other types of road data from on-board vehicle sensors and processors located in vehicles, for example data source vehicle 302 and data source vehicle 304. Data source vehicle 302 and data source vehicle 304 may be located in a proximity of the current vehicle. In addition, other vehicles may also provide weather and road condition data for a possible route of the current vehicle. Further, the weather and road data source 310 may also collect road and weather data through crowdsourcing. Such data may be entered by individuals through the Internet using their observations and experiences at various locations. All such data may then be passed as data 312 to the road criticality scoring engine 330.

Data providers 320 may also provide weather and traffic information for the location of the vehicle, as well as for conditions along a possible route of the vehicle. For example, there are numerous Internet sites that monitor and forecast weather conditions, traffic conditions, wind conditions shown as input 318. Such entities may be classified as data providers 320 where such data may be passed as data 322 to the road criticality scoring engine 330.

Road criticality scoring engine 330 may accept the data outputs of the weather and road data source 310 and the data providers 320 and generate a road criticality score for the various reported conditions at the location of the vehicle. Further, the road criticality scoring engine 330 may also receive data, e.g., data 352 from the advanced driver assistance system 350 (ADAS 350) in the current vehicle. The ADAS 350 may collect weather and road data using a variety of sensors. For example, the ADAS 350 may include cameras, accelerometers, steering system sensors, body control sensors, that may be used to classify and quantify various weather and road conditions. Accordingly, the road criticality scoring engine 330 may use the data inputs, e.g., data 312, data 322, and data 352 to determine an overall road criticality score. Further, the road criticality scoring engine 330 may determine the overall road criticality score based on the vehicle location and one or more possible routes that may be travelled by the vehicle. Thus, the road criticality score may also be referred to as a route criticality score.

While the road criticality scoring engine 330 may be focused on data and conditions outside of the vehicle, the vehicle criticality scoring engine 340 may be directed to vehicle conditions. For example vehicle conditions may include information about the vehicle and evaluate the vehicle's sensitivity to environmental conditions. Such vehicle data may also be referred to as the vehicle measurement data. Further, vehicle information may include factors such as:
Vₓ Vehicle velocity;
Ψ Vehicle yaw;
Ψ Vehicle yaw rate;
y Lateral position;
\dot{y} Lateral velocity;
δ Steering angle;
A Vehicle dynamics matrix
B Vehicle dynamics steering input vector; and
B_{w} Vehicle dynamics wind input vector.
   Such vehicle information may be obtained from the ADAS 350 shown as data 354.

The vehicle criticality scoring engine 340 may then generate a vehicle criticality score based on the vehicle measurement data.

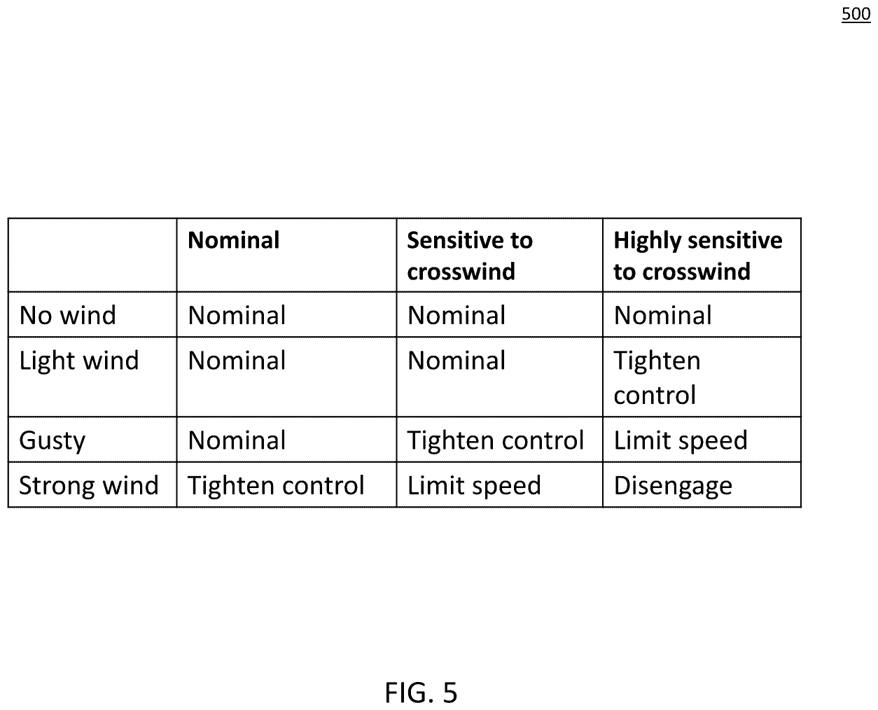

Control settings engine 360 may accept the road criticality score as data 332 and the vehicle criticality score as data 342. Further, control settings engine 360 may combine the road criticality score and the vehicle criticality score to determine if an action is required. The combination of the road criticality score and the vehicle criticality score may also be referred to as a criticality of a wind impact on the vehicle. As will be discussed in FIG. 5, depending upon the severity of the conditions, including the vehicle and the road, a warning, a restriction, or some type of adaptation may be appropriate, shown as action 362. For example, a warning may include a visual indicator or haptic feedback to the driver. A restriction may be a speed limit, for example reducing the speed of the vehicle to a predefined threshold under the current speed limit. An adaptation may include a steering torque applied to the steering system to assist keeping the vehicle in the proper lane or a warning signal that the vehicle may be leaving its lane, for example, a lane keeping assist feature. Such adaptations may be based on when the feedback, or the criticality of the wind impact exceeds a predefined threshold. For example, a visual warning may be generated when the criticality of the wind impact exceeds a first threshold and then an application of steering torque may be applied when the criticality of the wind impact exceeds a second threshold, where the second threshold is greater than the first threshold.

Further, the control settings engine 360 may also forward feedback information to the vehicle's advanced driver assistance system 350 that may incorporate such information into its control systems. The advanced driver assistance system 350, based on the data from the control settings engine 360 may initiate actions including continuing normal operation, disengaging one or more control systems, not allowing one or more actions such as increasing speed. The advanced driver assistance system 350 may also limit or decrease the speed of the vehicle or adjust various gains of control systems to limit or enhance body, speed, or other vehicle control systems.

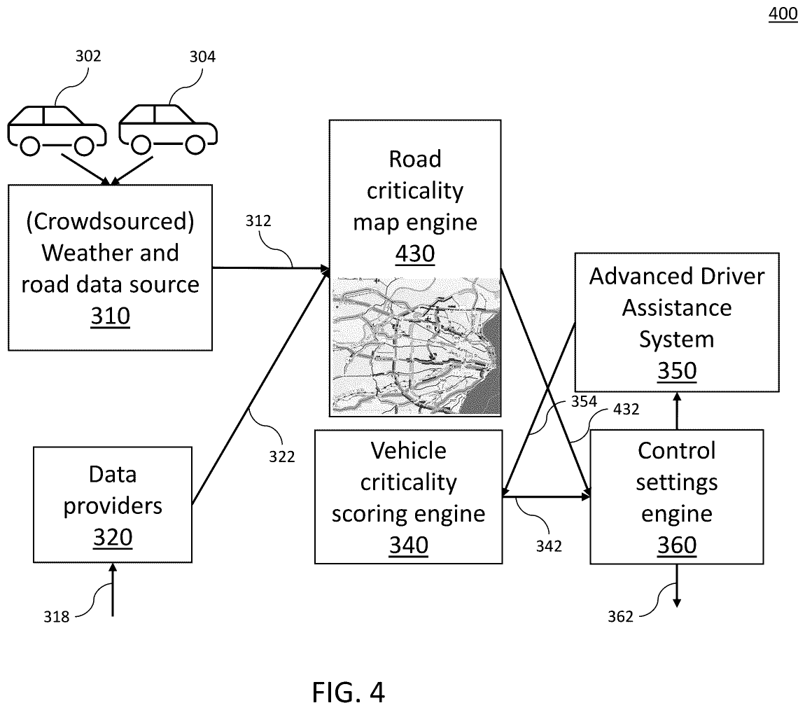

FIG. 4 is a block diagram of a map-based criticality scoring system 400, according to an embodiment of the present disclosure. While FIG. 3 focused on a criticality score for a specific vehicle, the map-based criticality scoring system 400 may be directed to a broader interpretation based on an area map of criticality. Further, the map-based criticality scoring system 400 may utilize many of the same components and operations of vehicle-specific criticality scoring system 300 but may be expanded as an area map accessible by multiple vehicles.

For example, the map-based criticality scoring system 400 may also include the weather and road data source 310, which may be crowdsourced such as through a vehicle automatically sharing data. The map-based criticality scoring system 400 may also include data source vehicle 302 and data source vehicle 304, data providers 320, a vehicle criticality scoring engine 340, an advanced driver assistance system 350 and a control settings engine 360. The weather and road data source 310 may collect data regarding the weather, road conditions, traffic, load conditions and other types of road data from on-board vehicle sensors and processors located in vehicles, for example data source vehicle 302 and data source vehicle 304. However, rather than collecting data directed to a specific vehicle or location, the data, e.g., data 312 and data 322, may be directed to a road criticality map engine 430.

Road criticality map engine 430 may accept the weather and road data source 310 and the data providers 320 and generate a road criticality map for a specific area or region of the world, based on the data 312 and data 322. The road criticality map engine 430 may be contained within a server where the data may cover any area or region of the world. Further, such data may be stored within one or more vehicles or through a cloud-based system architecture.

Road criticality map engine 430 may then provide road criticality information to any vehicle so equipped to receive and process such data. Rather than data for a single specific vehicle as discussed in FIG. 3, the road criticality map engine 430 may generate data for any vehicle within a mapped area. Control settings engine 360 may accept road criticality map information for a particular vehicle location or route of a vehicle as data 432 and the vehicle criticality score as data 342 as discussed above. Further, control settings engine 360 may combine the road criticality map information and the vehicle criticality score to determine if an action is required. As will be discussed in FIG. 5, depending upon the severity of the conditions, including the vehicle and the road, a warning, a restriction, or some type of adaptation may be appropriate, shown as action 362. For example, a warning may include a visual indicator or haptic feedback to the driver.

A restriction may be a speed limit, for example reducing the speed of the vehicle to a predefined threshold under the current speed limit. An adaptation may include a steering torque applied to the steering system to assist keeping the vehicle in the proper lane or a warning signal that the vehicle may be leaving its lane, for example, a lane keeping assist feature. In addition, the control settings engine 360 may also forward feedback information to the vehicle's advanced driver assistance system 350 that may incorporate such information into its control systems.

The advanced driver assistance system 350, based on the data from the control settings engine 360 may initiate actions including continuing normal operation, disengaging one or more control systems, not allowing one or more actions such as increasing speed. The advanced driver assistance system 350 may also limit or decrease the speed of the vehicle or adjust various gains of control systems to limit or enhance body, speed, or other vehicle control systems.

FIG. 5 is an example table 500 of control settings for adaption to wind and wind sensitivity, according to an embodiment of the present disclosure. Table 500 is an example of possible settings and in practice, there may be multiple such tables, for example, one for crosswinds, another for slippery road conditions, another one for simultaneous crosswinds and slippery roads and so forth.

In the example of being highly sensitive to crosswind, for example when hauling a trailer on a car, and there is a light wind, the table 500 indicates a “tighten control” is appropriate. A vehicle control system, for example, the advanced driver assistance system 350, may need to trade off comfort for safety. For example, in such a “tighten control” situation a high gain or high bandwidth and tight control may react faster and harder to a wind disturbance. For instance, a tightened control may result in smaller deviations from the desired path during lane keeping, but also may result in more erratic behavior of the vehicle and steering wheel, which can be disconcerting to the driver. Thus, in an embodiment, the use of high bandwidth control may be done when absolutely necessary, for example in gusty conditions when the vehicle is sensitive to crosswind of even with light winds when the vehicle is highly sensitive to crosswind, or with strong winds and even nominal sensitivity to crosswind.

As table 500 indicates, above the tighten control adaptation the system may limit a vehicle speed or even lower the speed to ensure stability and to possibly simultaneously tighten the control of a lane centering control. In even more severe situations the adaptation may include a disengaging of an advanced driver assistance system.

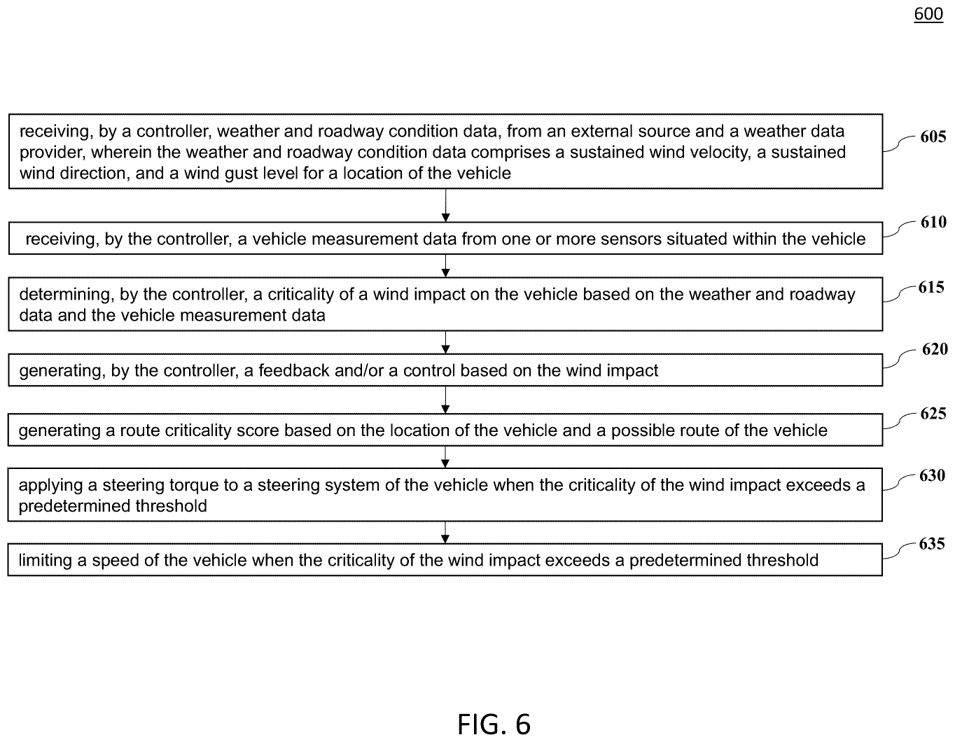

FIG. 6 is an illustration of a method 600 of vehicle control adaptation to external environmental conditions, according to an embodiment of the present disclosure. Step 605 may include receiving, by a controller, wind data inputs, wherein the wind data inputs are based on a location of a vehicle and include a sustained wind velocity, a sustained wind direction, and a wind gust level. As discussed in FIG. 1, wind may consist of two different components that include a sustained wind component and a wind gust component. The sustained wind component may be thought of as predictable and observable with a fairly consistent velocity and direction at a given point in time. In contrast, the wind gust component may be hard to predict or observe, contains a high bandwidth component and possibly a very erratic set of directions.

Further, as shown in FIGS. 2A and 2B, the strength and direction of sustained wind and wind gusts may vary based on location. For example, the sustained wind direction in FIG. 2A east of Norfolk is shown to be in blowing in a northeast direction while just west of Norfolk the wind is shown to be blowing in a south by southwest direction.

Step 610 may include receiving, by the controller, a vehicle measurement data from one or more sensors situated within the vehicle. As discussed regarding FIG. 3 and FIG. 4, the vehicle criticality scoring engine 340 may be directed to vehicle conditions, or vehicle measurements that may include a velocity of the vehicle, a yaw measurement, a yaw rate, a lateral position, a lateral velocity, and a steering angle. Given the shape and dynamics of a vehicle, which may be different from vehicle to vehicle. For example, the wind resistance of a box truck may be vastly different than that of a low-slung sports vehicle. Thus, the vehicle may be associated with one or more attributes that may be characterized by a vehicle dynamics matrix, a vehicle dynamics steering input vector, and a vehicle dynamics wind input vector. Such attributes, combined with other vehicle measurement data may model the effects of a wind impact on the vehicle.

Step 615 may include determining, by the controller, a criticality of a wind impact on the vehicle based on the weather and roadway data and the vehicle measurement data. As discussed in step 610, a vehicle may be characterized by one or more dynamics matrixes or vectors, that may predict the results of a wind impact on the vehicle, for example the box truck example may be highly susceptible to a crosswind impact that may affect the drivability of the vehicle and thus may require some amount of steering assistance or other corrective action including some type of warning to the driver. Also, as discussed in FIG. 5 the criticality of a wind impact may also depend on the sensitivity of the vehicle to crosswinds, for example a vehicle pulling a trailer may be more sensitive to crosswind and gusts than the vehicle without the trailer.

Step 620 may include generating, by the controller, a feedback and/or a control based on the criticality of the wind impact. As discussed in FIG. 3 and FIG. 4, an action 362 may be generated by control settings engine 360 based on the vehicle criticality scoring engine 340, the road criticality scoring engine 330, and the road criticality map engine 430. The action 362 may be a warning such as a visual indicator or haptic feedback to the driver, or a restriction such as a limit on vehicle speed, or by reducing the speed of the vehicle to a predefined threshold under the current speed limit. The action 362 may also bed an adaptation such as a steering torque applied to the steering system to assist keeping the vehicle in the proper lane or a warning signal that the vehicle may be leaving its lane, for example, a lane keeping assist feature.

Step 625 may include generating a route criticality score based on the location of the vehicle and a possible route of the vehicle. As discussed in FIG. 3, the road criticality scoring engine 330 may accept the data outputs of the weather and road data source 310 and the data providers 320 and generate a road criticality score for the various reported conditions at the location of the vehicle. The road criticality scoring engine 330 may further determine the overall road criticality score based on the vehicle location and one or more possible routes that may be travelled by the vehicle. Thus, the road criticality score may also be referred to as a route criticality score.

Step 630 may include applying a steering torque to a steering system of the vehicle when the criticality of the wind impact exceeds a predetermined threshold. As discussed in FIG. 3, the controller may generate feedback and/or a control based on the criticality of the wind impact where the control may include an adaptation such as a steering torque applied to the steering system to assist keeping the vehicle in the proper lane or a warning signal that the vehicle may be leaving its lane, for example, a lane keeping assist feature. Such adaptations may be based on when the feedback, or the criticality of the wind impact exceeds a predefined threshold. For example, a visual warning may be generated when the criticality of the wind impact exceeds a first threshold and then an application of steering torque may be applied when the criticality of the wind impact exceeds a second threshold, where the second threshold is greater than the first threshold.

Step 635 is similar to step 630 and may include limiting a speed of the vehicle when the criticality of the wind impact exceeds a predetermined threshold. As discussed in FIG. 3, a restriction may include limiting the speed of the vehicle based on the criticality of the wind impact on the vehicle. Thus, when the criticality of the wind impact exceeds a first threshold a limitation of vehicle speed may be imposed.

Method 600 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A system for vehicle control adaptation to external environmental conditions comprising:
a controller situated within a vehicle configured to receive, from an external source, weather and roadway condition data, based on a location of the vehicle, wherein the weather and roadway condition data comprises a sustained wind velocity, a sustained wind direction, and a wind gust level;
the controller further configured to receive a vehicle measurement data from one or more sensors situated within the vehicle; and
the controller further configured to determine a route criticality score based on the weather and roadway data and the vehicle measurement data.

2. The system of claim 1, wherein the external source is crowd sourced automatically from other vehicles.

3. The system of claim 1, wherein the weather and roadway condition data further comprise traffic data.

4. The system of claim 1, wherein the controller is further configured to generate a feedback and/or a control based on the route criticality score.

5. The system of claim 1, wherein the vehicle measurement data comprise a velocity of the vehicle, a steering angle of the vehicle, and a yaw rate of the vehicle.

6. The system of claim 4, wherein the feedback and/or the control comprises a steering torque applied to a steering system of the vehicle.

7. The system of claim 4, wherein the feedback and/or the control comprises a limiting of vehicle speed.

8. A system for vehicle control adaptation to external environmental conditions comprising:
a controller situated within a vehicle configured to access, from a server, a road criticality map, wherein the road criticality map is based on geographically mapped condition data from an external source, wherein the road criticality map comprises a sustained wind velocity, a sustained wind direction, and a wind gust level;
the controller further configured to receive a vehicle measurement data from one or more sensors situated within the vehicle;
the controller further configured to determine a criticality of wind impact on the vehicle based on the road criticality map and the vehicle measurement data; and
the controller further configured to generate a feedback and/or a control based on the criticality of wind impact on the vehicle.

9. The system of claim 8, wherein the road criticality map is a shared map of road criticality for a geographic area.

10. The system of claim 8, wherein the road criticality map further comprises traffic data.

11. The system of claim 8, wherein the external source is crowd sourced automatically from other vehicles.

12. The system of claim 8, wherein the vehicle measurement data comprise a velocity of the vehicle, a steering angle of the vehicle, and a yaw rate of the vehicle.

13. The system of claim 8, wherein the feedback and/or the control comprises a steering torque applied to a steering system of the vehicle.

14. The system of claim 8, wherein the feedback and/or the control comprises a limiting of vehicle speed.

15. The system of claim 8, wherein the feedback and/or the control comprises a warning indication to an occupant of the vehicle.

16. A method for vehicle control adaptation to external environmental conditions comprising:
receiving, by a controller, weather and roadway condition data, from an external source, wherein the weather and roadway condition data comprises a sustained wind velocity, a sustained wind direction, and a wind gust level for a location of a vehicle;
receiving, by the controller, a vehicle measurement data from one or more sensors situated within the vehicle;
determining, by the controller, a criticality of a wind impact on the vehicle based on the weather and roadway data and the vehicle measurement data; and
generating, by the controller, a feedback and/or a control based on the criticality of the wind impact.

17. The method of claim 16, wherein the vehicle measurement data comprises a velocity of the vehicle, a steering angle of the vehicle, and a yaw rate of the vehicle.

18. The method of claim 16, further comprising applying a steering torque to a steering system of the vehicle when the criticality of the wind impact exceeds a predetermined threshold.

19. The method of claim 16, further comprises limiting a speed of the vehicle when the criticality of the wind impact exceeds a predetermined threshold.

20. The method of claim 16, further comprising generating a route criticality score based on the location of the vehicle and a possible route of the vehicle.
